(19) United States
(12) Patent Application Publication
(10) Pub. No.: US 2026/0311597 A1
(43) Pub. Date: Oct. 8, 2026

(54) BLIND SPOT WARNING SYSTEM WITH HEDGING FOR PROMOTING DEFENSIVE DRIVING

(71) Applicant: MORGAN STATE UNIVERSITY, Baltimore, MD (US)

(72) Inventors: Di Yang, Baltimore, MD (US); Mansoureh Jeihani, Timonium, MD (US); Abolfazl M. Taherpourkomishani, Baltimore, MD (US)

(21) Appl. No.: 19/460,676

(22) Filed: Jan. 27, 2026

Related U.S. Application Data
(60) Provisional application No. 63/750,085, filed on Jan. 27, 2025.

(51) Int. Cl. G08G 1/16; B60Q 9/00

(52) U.S. Cl. CPC G08G 1/167; B60Q 9/008; G08G 1/162; G08G 1/163; G08G 1/166; B60Y 2200/148

(57) ABSTRACT

A collision avoidance system reduces blind spot related crashes by implementing a “hedging” strategy that warns both heavy vehicle drivers and passenger vehicle drivers. The system includes sensors on a heavy vehicle detecting when passenger vehicles enter defined blind spot zones (rear: 13 m×3.3 m; sides: vehicle length+5 m×3.3 m). A processor determines blind spot zone occupancy and a communication module transmits V2V warning signals to passenger vehicles using DSRC or C-V2X protocols. The passenger vehicles receive warnings and activate visual displays showing “WARNING: ENTERING BLIND SPOTS OF HEAVY VEHICLE” and/or auditory beeping alerts. The heavy vehicle driver also receives internal cab warnings. Empirical testing with 43 participants demonstrated statistically significant behavioral changes (p<0.05) in time spent in blind spots and speed adjustments when warnings were provided, validating the system's effectiveness in promoting defensive driving and reducing crash risk.

### CROSS-REFERENCE TO RELATED APPLICATIONS

This application claims priority to U.S. Provisional Patent Application No. 63/750,085, filed Jan. 27, 2025, entitled “Blind Spot Warning with Hedging to Promote Defensive Driving Around Trucks,” the specification of which is incorporated herein by reference in its entirety.

### GOVERNMENT RIGHTS

This invention was made with government support under grant number 69A3552348303 awarded by the U.S. Department of Transportation. The government has certain rights in the invention.

### FIELD OF THE INVENTION

The present invention relates generally to vehicle safety systems, and more particularly to a driver warning system that utilizes vehicle-to-vehicle communication to provide blind spot warnings to drivers of passenger vehicles when they enter blind spot zones of heavy vehicles.

### BACKGROUND

Traffic crashes involving large trucks constitute a significant safety concern. According to the National Safety Council, trucks were involved in 107,000 injury crashes and 4,842 fatal crashes in the United States in 2020 alone, resulting in 4,965 fatalities. Large trucks account for only 4% of all registered vehicles but represent 9% of all vehicles involved in fatal crashes. One major contributing factor to truck-related crashes is the presence of natural blind spots, also known as “No Zones,” surrounding large trucks.

Due to their massive size, trucks have larger and more numerous blind spots compared to passenger vehicles. These blind spots exist at the front, rear, and both sides of trucks. Even after adjusting all side and rearview mirrors, truck drivers can completely miss passenger vehicles present in these blind spots, potentially leading to devastating consequences.

Intelligent transportation system (“ITS”) technologies have been developed to warn truck drivers of road users in their blind spots. Blind Spot Warning (“BSW”) systems alert truck drivers if the space adjacent to the truck is occupied during lane change attempts. However, despite the growing deployment of BSW technology on trucks, the number of truck-related crashes continues to rise. The total number of crashes involving large trucks increased by 33% from 2011 to 2020.

Critical statistics reveal that drivers of passenger vehicles initiate approximately 83% of safety-related traffic events involving heavy trucks, and among all crashes caused by trucks' blind spots, drivers of passenger vehicles initiate the vast majority (over 90%), not truck drivers. These statistics indicate that merely alerting truck drivers is insufficient to reduce the safety risk induced by truck blind spots.

Previous technologies have focused primarily on warning the truck driver. For example, U.S. Pat. No. 11,120,691 discloses a collision warning system where a subject vehicle uses sensor data to warn surrounding vehicles about collision hazards between other vehicles by flashing the subject vehicle's hazard lights. However, this system warns about collisions between third parties rather than warning a driver that they themselves are entering a dangerous blind spot zone.

U.S. Pat. No. 6,133,851 describes a truck-mounted warning system that displays messages on external indicators attached to the truck to warn drivers they are in a blind spot. While this system alerts nearby drivers, it relies on physical display panels mounted externally on the truck itself, which may have limited visibility and require specific hardware installations.

U.S. Pat. No. 8,645,001 discloses a blind spot warning system using visual indicators such as lights embedded in a vehicle's steering wheel, dashboard, or mirrors to alert drivers about vehicles in their own blind spots. However, this system focuses on warning drivers about their own blind spots rather than warning passenger vehicle drivers when they enter a truck's blind spot.

None of the prior art systems implement a “hedging” strategy wherein both the truck driver and the passenger vehicle driver receive warnings when the passenger vehicle enters the truck's blind spot, thereby creating redundant safety measures. There remains a need for a system that promotes defensive driving among passenger vehicle drivers by actively warning them when they enter dangerous blind spot zones of trucks.

### SUMMARY OF THE INVENTION

In accordance with certain aspects of an embodiment of the invention, a Blind Spot Warning system with Hedging (BSW-H) is provided that issues warnings to both truck drivers and drivers of nearby passenger vehicles when the passenger vehicles enter truck blind spots. By incorporating the novel concept of “hedging,” the system provides dual warnings that act as mutual safeguards. If one driver fails to respond, the other can still take evasive action to avoid a potential collision.

In one aspect, the invention provides a collision avoidance system comprising: a monitoring vehicle including one or more sensors configured to detect positions and velocities of surrounding vehicles; a processor configured to determine when a target vehicle has entered a defined blind spot region associated with the monitoring vehicle; a communication module configured to transmit a warning signal to the target vehicle when the target vehicle is determined to be within the blind spot region; and wherein the warning signal causes a warning device within the target vehicle to present an alert to an occupant of the target vehicle indicating the target vehicle's proximity to the monitoring vehicle's blind spot, wherein the warning is provided independently of whether the monitoring vehicle's driver is aware of the target vehicle's presence.

The blind spot regions are defined as specific geometric zones: a rear blind spot extending approximately 13 meters from the rear bumper of the truck with a width of approximately 3.3 meters; a right-side blind spot extending from the front bumper along the truck's length and continuing approximately 5 meters past the rear bumper with a width of approximately 3.3 meters; and a left-side blind spot having similar dimensions as the right-side blind spot.

Statistical validation from a study involving 43 participants demonstrated significant behavioral changes when drivers received BSW-H warnings. The analysis showed statistically significant differences (p=0.033) in time spent in blind spots between scenarios with no warnings versus scenarios with combined visual and auditory warnings. Speed difference analysis revealed significant changes (p=0.011 for audio-visual warnings, p=0.002 for visual-only warnings) when comparing warning scenarios to the baseline, demonstrating that the BSW-H system effectively influenced driving behavior.

The invention may be implemented in a Connected Vehicle (“CV”) environment utilizing vehicle-to-vehicle (“V2V”) communication protocols such as Dedicated Short-Range Communications (“DSRC”) or Cellular V2X (“C-V2X”), though the invention is not limited to any particular communication technology.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a perspective view illustrating a heavy vehicle system with blind spot detection sensors and communication equipment according to an embodiment of the invention.

FIG. 2 is a top plan view showing the defined blind spot zones around a heavy vehicle according to an embodiment of the invention.

FIG. 3 is a block diagram of a BSW-H system architecture according to further aspects of an embodiment of the invention.

FIG. 4A is a front interior view of an exemplary passenger vehicle showing an in-vehicle visual warning display activated when the vehicle enters a truck blind spot.

FIG. 4B is a front interior view of the passenger vehicle of FIG. 4A showing both visual and auditory warning indicators activated.

FIG. 5 is a flowchart illustrating a method of detecting a vehicle entering a blind spot zone and transmitting warnings according to an embodiment of the invention.

FIG. 6 is a block diagram showing a communication protocol architecture for V2V transmission of blind spot warnings according to further aspects of an embodiment of the invention.

FIG. 7A is a graph showing time duration spent in blind spot zones across different warning scenarios from experimental validation.

FIG. 7B is a graph showing speed differences before and after receiving warnings across different scenarios from experimental validation.

FIG. 8 is a schematic diagram showing multiple passenger vehicles in various positions relative to a heavy vehicle and the corresponding blind spot zones that trigger warnings.

### DETAILED DESCRIPTION OF THE INVENTION

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

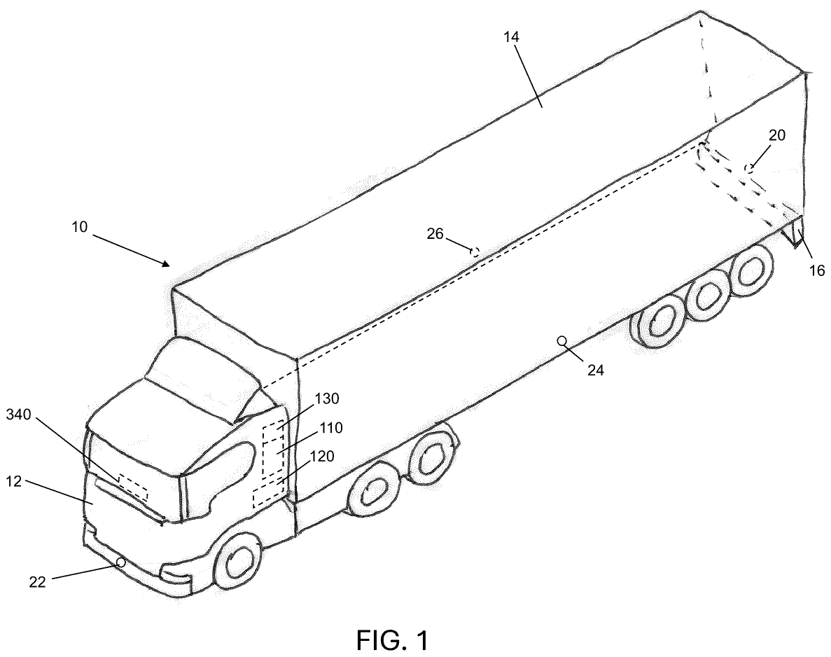

Referring to FIG. 1, a heavy vehicle (shown generally at 10) is illustrated equipped with a BSW-H system according to the present invention. The term “heavy vehicle” as used herein refers to trucks, tractor-trailers, buses, and other large commercial vehicles having a gross vehicle weight rating (GVWR) exceeding 10,000 pounds. The heavy vehicle 10 includes a tractor portion 12 and may include a trailer portion 14. The BSW-H system includes a plurality of sensors 20, 22, 24, 26 positioned around the heavy vehicle 10, a central processing unit 110, a communication module 120, and optionally a power supply 130 (although in certain configurations the BSW-H system may be powered by the power supply of the heavy vehicle 10).

The sensors may include radar sensors, LiDAR sensors, cameras, ultrasonic sensors, or combinations thereof. In a preferred embodiment, the sensor system comprises radar sensors positioned at the rear 20, front 22, left side 24, and right side 26 of the heavy vehicle 10 to provide 360-degree coverage of the surrounding environment. The sensors 20, 22, 24, 26 are configured to detect the presence, position, velocity, and heading of surrounding vehicles within a detection range of at least 50 meters, and preferably at least 100 meters.

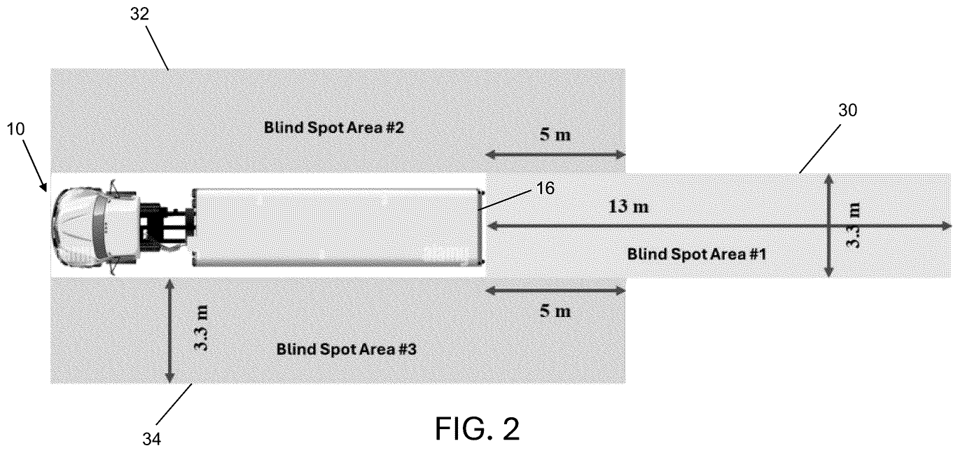

As shown in FIG. 2, the BSW-H system defines three primary blind spot zones around the heavy vehicle 10. Blind Spot Zone #1 (reference numeral 30) comprises a rear blind spot region extending approximately 13 meters (±2 meters) from the rear bumper 16 of the heavy vehicle 10 and spanning a width of approximately 3.3 meters (±0.5 meters), corresponding to one traffic lane width. It was found that truck drivers have significantly impaired rear visibility within this range.

Blind Spot Zone #2 (reference numeral 32) comprises a right-side blind spot region extending from the front bumper of the tractor 12 along the entire length of the heavy vehicle 10 and continuing approximately 5 meters (±1 meter) past the rear bumper 16, with a width of approximately 3.3 meters (±0.5 meters). This zone represents the most critical blind spot area, as mirror-relevant crashes involving the right side of large trucks are more than four times as common as those involving the left side.

Blind Spot Zone #3 (reference numeral 34) comprises a left-side blind spot region with dimensions substantially similar to Blind Spot Zone #2, extending from the front bumper along the vehicle length plus approximately 5 meters past the rear bumper, with a width of approximately 3.3 meters.

These dimensions may be adjusted based on the specific vehicle configuration, including whether a trailer is attached, the length of the trailer, and visibility conditions. The central processing unit 110 stores dimensional parameters for each blind spot zone and can dynamically adjust the boundaries based on real-time conditions.

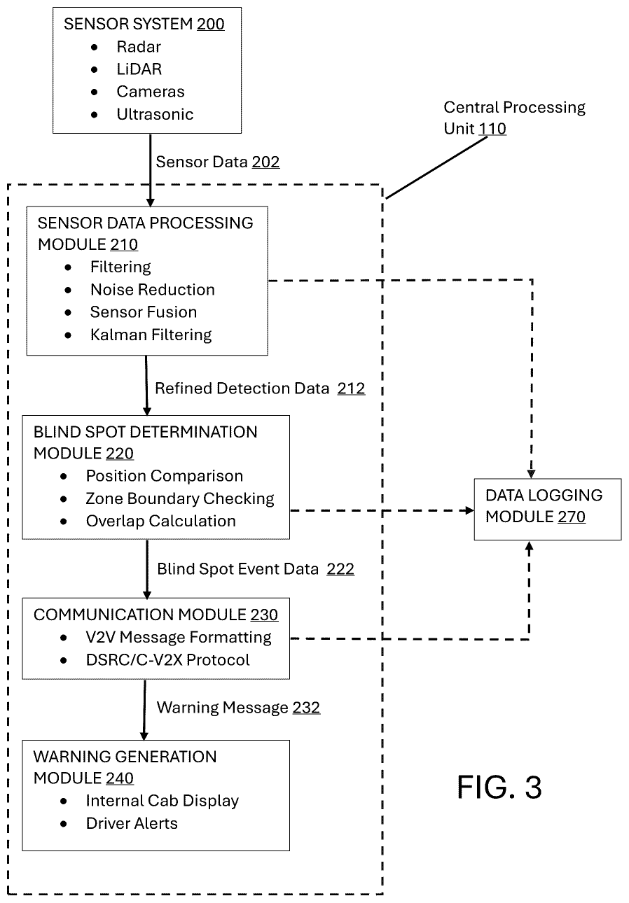

Referring to FIG. 3, the BSW-H system architecture comprises several interconnected modules. The sensor system 200 continuously acquires data about the surrounding environment, generating sensor data 202 at a frequency of at least 10 Hz, and preferably at least 100 Hz. The sensor data 202 includes position coordinates, velocity vectors, and object classification information for detected vehicles.

A sensor data processing module 210 receives the raw sensor data 202 and performs filtering, noise reduction, and sensor fusion operations to generate refined detection data 212. When multiple sensors detect the same object, the processing module 210 applies Kalman filtering or similar state estimation techniques to produce a unified track for each detected vehicle.

A blind spot determination module 220 receives the refined detection data 212 and determines whether any detected vehicle has entered one of the defined blind spot zones 30, 32, 34. The module 220 compares the position coordinates of each detected vehicle against the geometric boundaries of the blind spot zones. The module 220 further calculates an overlap percentage indicating what portion of the detected vehicle's footprint lies within a blind spot zone. In one embodiment, a vehicle is considered to have “entered” a blind spot when at least, for example, 25% of its footprint overlaps with the blind spot zone boundary. In a case in which the detected vehicle is itself a heavy vehicle or other large vehicle type, the processor may adjust the overlap percentage threshold or maintain the same threshold, recognizing that the larger footprint of heavy vehicles will trigger warnings at greater absolute distances, which provides beneficial earlier notification given the increased collision severity risk between two large vehicles. The system may utilize vehicle classification data from the sensor system 200 or from vehicle-to-vehicle communications (e.g., vehicle type information transmitted in Basic Safety Messages) to identify when the target vehicle is a heavy vehicle and optionally apply vehicle-type-specific thresholds or warning parameters.

The blind spot determination module 220 generates blind spot event data 222 including: (i) an identifier of which blind spot zone has been entered (Zone #1, #2, or #3); (ii) a timestamp of entry; (iii) the overlap percentage; (iv) the velocity and heading of the detected vehicle; and (v) an estimated time to complete passage through the blind spot.

A communication module 230 receives the blind spot event data 222 and generates warning messages 232 for transmission to the detected vehicle. The communication module 230 formats the warning messages according to applicable V2V communication standards, such as the SAE J2735 or SAE J2945 standards for DSRC-based vehicle communications, or 3GPP standards for C-V2X communications. The warning message 232 includes at minimum: a message type identifier indicating a blind spot hazard warning, position coordinates of the heavy vehicle 10, identification of which blind spot zone has been entered, and optionally vehicle dynamics data such as the truck's velocity and intended maneuvers (e.g., upcoming lane change or turn).

In a particular exemplary embodiment, the communication module 230 utilizes a Dedicated Short-Range Communications (DSRC) transceiver operating in the 5.9 GHz band to transmit warning messages 232 directly to nearby vehicles equipped with compatible transceivers. In an alternative embodiment, the communication module 230 utilizes Cellular V2X (C-V2X) technology operating on LTE or 5G networks to transmit warnings to a warning generation module 240. In yet another embodiment, the system supports both DSRC and C-V2X for maximum compatibility.

The communication module 230 transmits warning messages 232 at a rate of at least 1 Hz when a vehicle occupies a blind spot, and preferably at 10 Hz to provide real-time updates as the relative positions change. The transmission continues for the entire duration that the detected vehicle remains within the blind spot zone and ceases within 100 milliseconds of the vehicle exiting the blind spot.

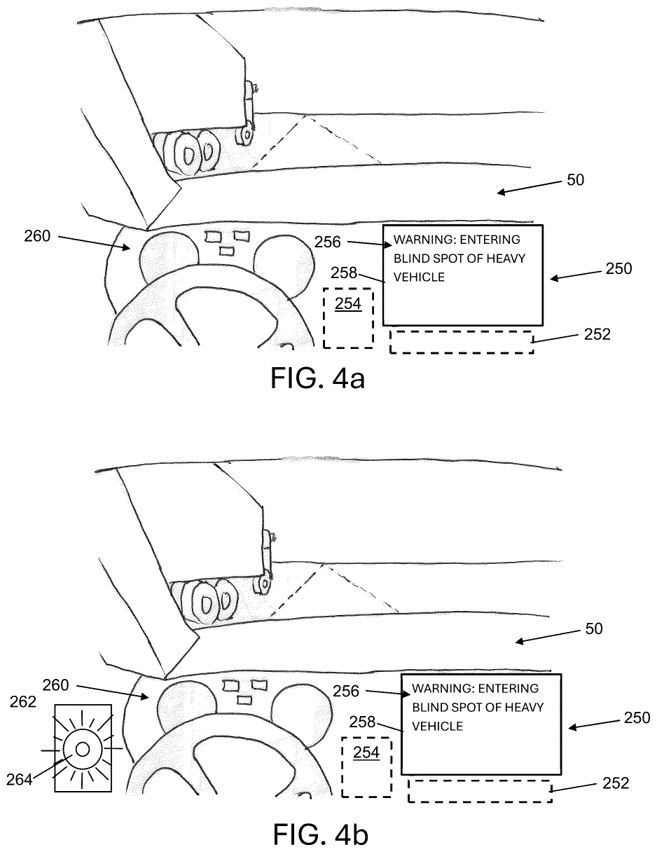

Referring to FIGS. 4A and 4B, a passenger vehicle 50 is illustrated equipped with a warning reception system 250. The passenger vehicle 50 includes a communication receiver 252 compatible with the transmission protocols used by the heavy vehicle's communication module 230. Upon receiving a warning message 232, the communication receiver 252 forwards the message to an onboard warning controller 254.

The warning controller 254 processes the received warning message to determine appropriate warning modalities. In a first embodiment shown in FIG. 4A, the controller 254 activates a visual warning indicator 256 on a dashboard display 258 or instrument cluster 260. The visual warning indicator 256 displays a message such as “WARNING: ENTERING BLIND SPOTS OF HEAVY VEHICLE” in a contrasting color, preferably red text on a black or white background, with a font size of at least 18 points to ensure visibility.

In a second embodiment shown in FIG. 4B, the warning controller 254 activates both the visual warning indicator 256 and an auditory warning indicator 262. The auditory warning may, in exemplary configurations, comprise a beeping sound generated by a speaker 264 integrated into the vehicle's audio system. Optionally, the heavy vehicle operator may temporarily disable the beeping sound in order to avoid unwanted distraction. The beeping sound has a frequency between 500 Hz and 3000 Hz, preferably approximately 1000 Hz, and a sound pressure level of at least 65 dB at the driver's position. The beeping sound repeats, for example, at one-second intervals for the duration that the vehicle remains in the blind spot.

Statistical validation from a controlled study demonstrated that combined visual and auditory warnings (Scenario S1) produced significantly different driver behavior compared to no warnings (Scenario S0), with p=0.033 for time duration in blind spot and p=0.011 for speed adjustment. Visual-only warnings (Scenario S2) also produced significant speed adjustments (p=0.002) compared to the baseline. Survey results indicated that 51.2% of participants preferred combined visual and auditory warnings, while 90.7% rated their experience with the system as “Excellent” or “Good,” and 86.0% believed BSW-H contributed to safer driving.

The BSW-H system includes a data logging module 270 (FIG. 3) that records operational data for subsequent analysis and system optimization. The data logging module 270 stores data at, for example, intervals of 0.01 seconds (100 Hz) including vehicle trajectory data, blind spot entry/exit events, warning transmission timestamps, and vehicle dynamics parameters.

For each blind spot event, the system records a comprehensive dataset including variables such as: speed (mph or km/h), average speed difference measured over 5-second intervals before and after warning receipt, time spent in blind spot zone (seconds), throttle position (0-1 normalized), brake force (0-1 normalized), distance along road (meters), GPS coordinates, heading angle, lateral acceleration, and vehicle type classifications.

Key performance metrics for evaluating BSW-H effectiveness include: (1) Time Duration Spent in Blind Spot, defined as the time interval from blind spot zone entry until exit, typically ranging from 0.029 to 13.567 seconds with a mean of approximately 2.8-2.9 seconds; and (2) Average Speed Difference, calculated by comparing the average vehicle speed during a 5-second interval before receiving the warning with the average speed during a 5-second interval after receiving the warning, with positive values indicating acceleration and negative values indicating deceleration.

As described in detail below, experimental results from 43 participants driving three scenarios (S0: no warning baseline; S1: combined visual and auditory warnings; S2: visual-only warnings) revealed mean time durations of 2.779 seconds (S0), 2.933 seconds (S1), and 2.900 seconds (S2). Kruskal-Wallis testing indicated significant overall differences (p=0.029), with post-hoc pairwise Wilcoxon testing showing significant differences between S0 and S1 (p=0.033).

For average speed differences, means were 0.128 km/h (S0), 0.258 km/h (S1), and 0.297 km/h (S2), with Kruskal-Wallis testing showing highly significant differences (p=0.001). Pairwise comparisons revealed significant differences between S0 and S1 (p=0.011) and between S0 and S2 (p=0.002), but no significant difference between S1 and S2 (p=1.000), indicating that both warning modalities effectively altered driver behavior.

The comprehensive empirical study was conducted involving 43 participants who drove through simulated traffic scenarios containing large trucks with defined blind spot zones in order to validate the effectiveness of the BSW-H system. The study employed a within-subjects experimental design where each participant experienced three different warning scenarios in randomized order to control for learning effects and individual driving style variations.

The three experimental scenarios were defined as follows:

Scenario S0 (Baseline Control): Participants drove through traffic scenarios containing trucks with blind spots, but received no warnings when entering blind spot zones. This scenario established baseline driving behavior in the presence of truck blind spots without any intervention.

Scenario S1 (Combined Visual and Auditory Warnings): Participants received both visual warnings displayed on the vehicle's dashboard showing the message “WARNING: ENTERING BLIND SPOTS OF HEAVY VEHICLE” and simultaneous auditory warnings consisting of beeping sounds at approximately one-second intervals while their vehicle remained within any truck blind spot zone.

Scenario S2 (Visual-Only Warnings): Participants received only visual warnings displayed on the dashboard with the same warning message as Scenario S1, but without any accompanying auditory alerts.

Each participant completed multiple driving trials encompassing various traffic conditions, truck positions, and blind spot entry situations. The experimental environment was designed to replicate realistic highway driving conditions where passenger vehicles frequently interact with large trucks. The study recorded 106 distinct variables at 0.01-second intervals (100 Hz sampling rate) for each participant throughout all scenarios, capturing comprehensive data on vehicle dynamics, driver inputs, and spatial relationships.

Two primary dependent variables were selected as key performance indicators for evaluating BSW-H system effectiveness:

Time Duration Spent in Blind Spot: This metric quantifies the total time interval from the moment a participant's vehicle entered a truck blind spot zone until the moment the vehicle completely exited that zone. Time duration provides a direct measure of exposure to collision risk, as longer durations in blind spots increase the probability of a truck driver initiating a lane change or turn while unaware of the passenger vehicle's presence. The minimum recorded time was 0.029 seconds (representing vehicles that quickly transited through blind spot edges), while the maximum was 13.567 seconds (representing vehicles that traveled alongside trucks for extended periods).

Average Speed Difference: This metric captures behavioral response to warning receipt by comparing average vehicle speed during a 5-second interval immediately before receiving a warning with average vehicle speed during a 5-second interval immediately after receiving the warning. Positive values indicate acceleration (speeding up to exit the blind spot more quickly), while negative values indicate deceleration (slowing down to drop back behind the blind spot zone). This metric reveals whether drivers actively modify their speed in response to warnings, demonstrating conscious behavioral adaptation.

### Experimental Results—Time Duration in Blind Spot Zones

Table 1 presents the descriptive statistics and statistical test results for time duration spent in truck blind spot zones across the three experimental scenarios.

TABLE 1
Time Duration Spent in Blind Spot Zones (seconds)

| Scenario | Mean (sec) | Range |
|---|---|---|
| S0 (No Warning) | 2.779 | 0.029-13.567 |
| S1 (Visual + Audio) | 2.933 | 0.029-13.567 |
| S2 (Visual Only) | 2.900 | 0.029-13.567 |

Statistical Testing:
Kruskal-Wallis Test (overall): p = 0.029*
Post-hoc Pairwise Wilcoxon Tests:
S0 vs. S1: p = 0.033*
S0 vs. S2: p = 0.076 (not significant)
S1 vs. S2: p = 1.000 (not significant)
*Indicates statistical significance at α = 0.05 level

The Kruskal-Wallis non-parametric test was employed rather than parametric ANOVA due to the non-normal distribution of time duration data, which exhibited right-skew typical of time-based measurements where most events occur quickly but occasional prolonged events extend the upper tail. The overall Kruskal-Wallis test yielded p=0.029, indicating statistically significant differences among the three scenarios at the conventional α=0.05 significance level.

Post-hoc pairwise comparisons using Wilcoxon signed-rank tests revealed that the statistically significant overall effect was driven primarily by the difference between Scenario S0 (no warning) and Scenario S1 (combined visual and auditory warnings), with p=0.033 [2](2]. This finding demonstrates that the combined warning modality produced measurably different driver behavior compared to the baseline condition with no warnings. The comparison between S0 and S2 approached but did not reach statistical significance (p=0.076), while S1 and S2 showed no significant difference from each other (p=1.000).

Interpretation of these results indicates that providing warnings to passenger vehicle drivers, whether visual-only or combined visual-auditory, tends to slightly increase the mean time spent in blind spots (2.933 and 2.900 seconds respectively) compared to the no-warning baseline (2.779 seconds). This counterintuitive finding does not indicate reduced safety; rather, it likely reflects a measurement artifact where drivers receiving warnings became more aware of blind spot zones and may have taken slightly longer to assess the situation and determine the appropriate evasive maneuver, whereas drivers without warnings passed through blind spots without awareness or deliberation. The critical safety benefit derives not from reduced time in blind spots, but from increased driver awareness and intentional speed adjustments, as demonstrated by the speed difference metric discussed below.

### Experimental Results—Average Speed Difference

Table 2 presents the descriptive statistics and statistical test results for average speed difference before and after warning receipt across the three experimental scenarios.

TABLE 2
Average Speed Difference Before/After Warning (km/h)

| Scenario | Mean (km/h) | Effect Size |
|---|---|---|
| S0 (No Warning) | 0.128 | Baseline |
| S1 (Visual + Audio) | 0.258 | +101.6% vs. S0 |
| S2 (Visual Only) | 0.297 | +132.0% vs. S0 |

Statistical Testing:
Kruskal-Wallis Test (overall): p = 0.001**
Post-hoc Pairwise Wilcoxon Tests:
S0 vs. S1: p = 0.011*
S0 vs. S2: p = 0.002**
S1 vs. S2: p = 1.000 (not significant)
*Indicates statistical significance at α = 0.05 level
**Indicates high statistical significance at α = 0.01 level

The speed difference metric revealed highly significant differences among scenarios, with the overall Kruskal-Wallis test yielding p=0.001, indicating strong statistical evidence that warning provision affects driver speed adjustment behavior. The positive mean values across all scenarios indicate that drivers, on average, increased their speed after entering blind spot zones, suggesting a natural tendency to accelerate through potentially hazardous areas.

Critically, the magnitude of speed adjustment more than doubled when warnings were provided. The baseline scenario S0 showed a mean speed increase of only 0.128 km/h, representing minimal or unconscious speed variation. In contrast, Scenario S1 (combined warnings) showed a mean speed increase of 0.258 km/h (a 101.6% increase over baseline) with statistical significance of p=0.011. Scenario S2 (visual-only warnings) showed an even larger mean speed increase of 0.297 km/h (a 132.0% increase over baseline) with high statistical significance of p=0.002.

The lack of significant difference between S1 and S2 (p=1.000) indicates that both visual-only and combined visual-auditory warnings are approximately equally effective at prompting speed adjustments. However, user preference data discussed below suggests that combined warnings may be preferable for other reasons including subjective comfort and confidence.

These results demonstrate that the BSW-H system successfully modifies driver behavior by prompting more aggressive speed adjustments when drivers enter truck blind spots. By accelerating more decisively, drivers reduce their time in the most dangerous positions relative to trucks and more actively manage their spatial relationship with large vehicles. This behavioral modification represents the fundamental safety benefit of the hedging approach: even if truck drivers remain unaware of passenger vehicles in their blind spots, the passenger vehicle drivers receive independent warnings and take evasive action.

In addition to objective performance metrics, the study collected subjective user feedback through post-experiment surveys administered to all 43 participants.

When asked to indicate their preferred warning modality, 51.2% of participants selected combined visual and auditory warnings (Scenario S1) as their most preferred option. This preference majority suggests that while visual-only warnings are statistically effective at modifying behavior, many drivers appreciate the additional alerting function of auditory warnings, particularly in situations where visual attention may be divided among multiple dashboard displays, mirrors, and the forward roadway.

When asked to rate their overall experience with the BSW-H system, 90.7% of participants rated their experience as either “Excellent” or “Good,” indicating strong user acceptance of the warning system concept. Only 9.3% rated their experience as neutral, fair, or poor, suggesting minimal user resistance or annoyance with the warning interventions.

Most significantly, when asked whether they believed the BSW-H system contributed to safer driving around large trucks, 86.0% of participants responded affirmatively. This high level of perceived safety benefit indicates that drivers recognize the value of receiving warnings about truck blind spots and believe such warnings enhance their situational awareness and safety.

The experimental validation demonstrates both statistical significance (p-values indicating results unlikely due to chance) and practical significance (meaningful real-world safety implications). The statistically significant differences in speed adjustment behavior (p=0.011 for S1 vs. S0, p=0.002 for S2 vs. S0) provide strong evidence that the BSW-H system produces measurable and reproducible effects on driver behavior.

The practical significance derives from the hedging safety concept: by warning passenger vehicle drivers independently of truck driver awareness, the system creates redundant safety mechanisms. If either the truck driver or the passenger vehicle driver responds appropriately to blind spot hazards, potential collisions can be avoided. Given that passenger vehicle drivers initiate over 90% of crashes caused by truck blind spots, providing direct warnings to these drivers addresses the primary causal factor in such crashes.

The combination of statistically significant behavioral changes, high user acceptance ratings, and strong perceived safety benefits validates the BSW-H system as an effective intervention for reducing truck-related blind spot crashes. These experimental results demonstrate unexpected results that exceed what would be predicted from mere combination of known blind spot detection and vehicle-to-vehicle communication technologies.

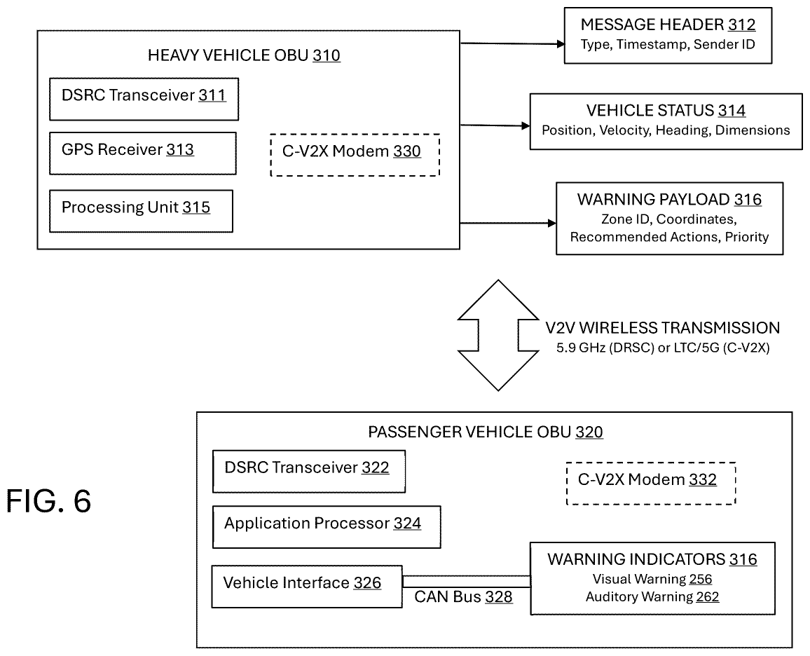

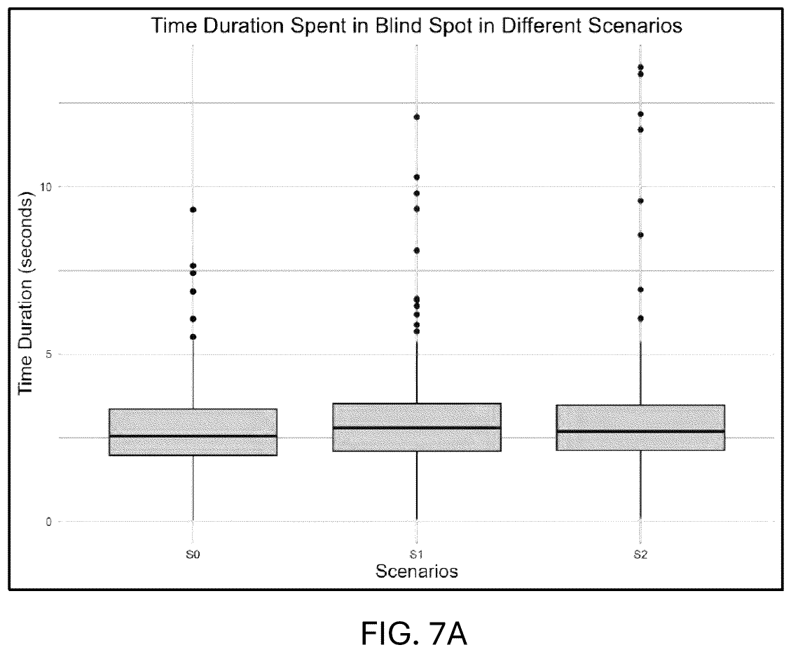

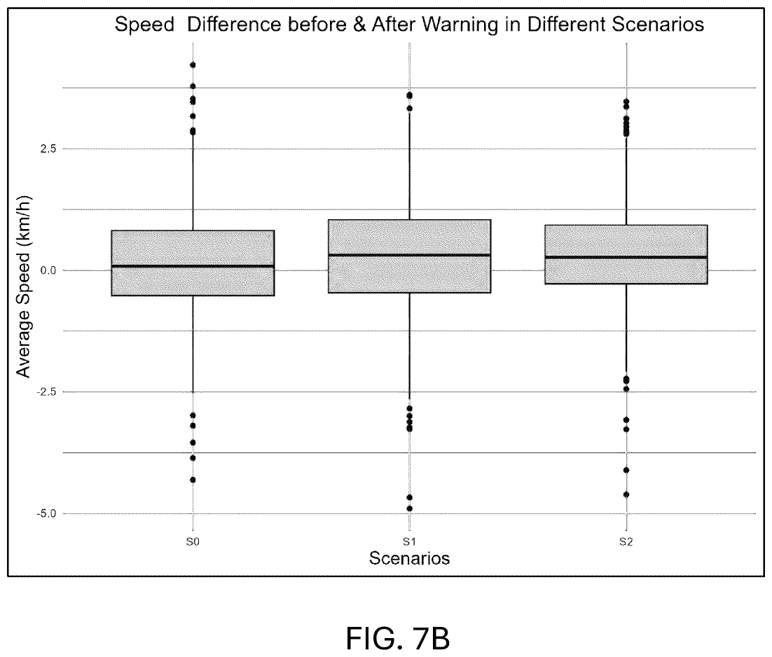

Referring next to FIG. 6, the communication architecture 300 for BSW-H implementation is illustrated. In a DSRC-based embodiment, the heavy vehicle 10 includes an On-Board Unit (“OBU”) 310 comprising a DSRC transceiver 311, GPS receiver 313, and Processing Unit 315. The OBU 310 broadcasts Basic Safety Messages (“BSMs”) at 10 Hz containing the vehicle's position, heading, speed, and vehicle dimensions. When the blind spot determination module 220 detects a vehicle in a blind spot zone, the OBU 310 generates and transmits a specialized alert message conforming, for example, to SAE J2735 message formats.

The alert message includes a message header 312 with message type, timestamp, and sender identification; a vehicle status section 314 containing the heavy vehicle's current position, velocity, heading, and dimensions; and a warning payload section 316 specifying the blind spot zone identifier, coordinates defining the affected zone boundary, recommended driver actions (e.g., “accelerate past truck” or “decelerate and maintain safe following distance”), and alert priority level.

Passenger vehicles equipped with compatible OBUs 320 receive the broadcast messages via their DSRC transceivers 322. An application processor 324 within the passenger vehicle OBU 320 evaluates whether the passenger vehicle's current position falls within the specified blind spot zone coordinates. If affirmative, the processor 324 triggers activation of the warning indicators 256, 262 through a vehicle interface 326 communicating with the passenger vehicle's controller area network (CAN) bus 328.

In a C-V2X embodiment, the heavy vehicle 10 includes a C-V2X modem 330 supporting PC5 direct communication mode for vehicle-to-vehicle messaging. The modem 330 transmits Cooperative Awareness Messages (CAMs) or Basic Safety Messages periodically and transmits Decentralized Environmental Notification Messages (DENMs) when blind spot hazards are detected. Passenger vehicles with C-V2X modems 332 receive these messages and process them analogously to the DSRC embodiment.

In a hybrid embodiment, the BSW-H system supports both DSRC and C-V2X transmission modes, automatically detecting and utilizing whichever protocol is supported by nearby passenger vehicles to maximize warning coverage.

The BSW-H system may implement adaptive warning strategies based on contextual factors. In an exemplary embodiment, the warning intensity or modality is adjusted based on the overlap percentage of the passenger vehicle within the blind spot zone. When overlap is less than 50%, a gentle visual warning may be presented. When overlap exceeds 50%, both visual and auditory warnings are activated. When overlap exceeds 75%, the auditory warning frequency increases to 0.5-second intervals instead of 1-second intervals.

In another exemplary embodiment, warning timing is adapted based on the relative closing speed between the heavy vehicle and the passenger vehicle. The system may calculate, for example, a Time to Collision (“TTC”) metric, and adjust warning activation thresholds accordingly. For example, if TTC is less than 3 seconds and the heavy vehicle driver has activated a turn signal indicating an intended lane change into the blind spot zone, the warning urgency level is elevated.

In yet another exemplary embodiment, the system implements driver behavior learning by monitoring how quickly and effectively drivers respond to warnings over time. If a particular driver consistently fails to respond to visual-only warnings but responds effectively to combined audio-visual warnings, the system adapts to automatically use combined warnings for that driver.

In an exemplary embodiment for night driving or adverse weather conditions, the system may increase the brightness and contrast of visual warnings, and may activate additional warning modalities such as haptic feedback through a vibrating steering wheel or seat cushion.

While a primary aspect of the invention is the warning provided to passenger vehicle drivers, the BSW-H system also includes conventional blind spot monitoring for the truck driver. An internal display 340 within the truck cab presents visual indicators to the truck driver when sensors detect vehicles in any of the blind spot zones 30, 32, 34. This dual-warning “hedging” approach ensures that if one driver (either the truck driver or passenger vehicle driver) fails to perceive or respond to the hazard, the other driver remains informed and can take evasive action.

The internal display 340 may show a top-down representation of the truck 10 with colored indicators showing occupied blind spot zones. In one embodiment, the display may use color coding: for example, green indicates no vehicles in blind spots, yellow indicates a vehicle approaching a blind spot zone, and red indicates a vehicle currently occupying a blind spot. Auditory alerts may also be provided to the truck driver through the truck's audio system.

The BSW-H system is designed for retrofit installation on existing heavy vehicles or integration during vehicle manufacturing. For retrofit applications, the sensor units 20, 22, 24, 26 mount to existing vehicle surfaces using brackets and fasteners, with wiring routed to the central processing unit 110 through existing cable paths. The central processing unit 110 integrates with the vehicle's existing electrical system, receiving power from the vehicle's 12V or 24V electrical bus, and interfacing with vehicle data networks (e.g., CAN bus) to access vehicle speed, turn signal status, and other relevant parameters.

For original equipment manufacturer (OEM) integration, the sensor units may be integrated flush with vehicle body panels, and the processing functionality may be incorporated into existing electronic control units (ECUs) to reduce component count and cost.

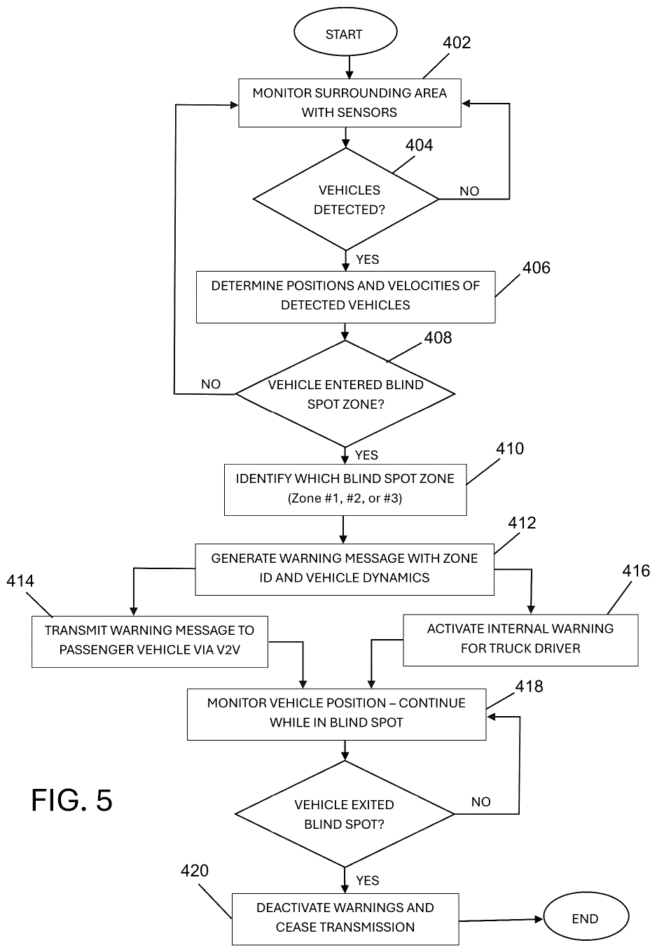

Referring to FIG. 5, a method 400 of operating the BSW-H system is illustrated. The method begins at step 402 with the sensor system continuously monitoring the area surrounding the heavy vehicle. At step 404, the system determines whether any vehicles are detected within a defined monitoring radius (e.g., 300 meters). If no vehicles are detected, the method returns to step 402 to continue monitoring.

If vehicles are detected, the method proceeds to step 406 where the system determines the positions and velocities of the detected vehicles. At step 408, the system evaluates whether any detected vehicle has entered one of the defined blind spot zones 30, 32, or 34. This determination involves comparing the vehicle's position coordinates against the geometric boundaries of each blind spot zone.

If no vehicle has entered a blind spot zone, the method returns to step 402. If a vehicle has entered a blind spot zone, the method proceeds to step 410 where the system identifies which specific blind spot zone (Zone #1, #2, or #3) has been entered. At step 412, the system generates a warning message including the blind spot zone identifier and relevant vehicle dynamics data. At step 414, the communication module transmits the warning message to the passenger vehicle via V2V communication. Simultaneously, at step 416, the system activates internal warnings for the truck driver on the cab display 340. At step 418, the system continues to monitor the passenger vehicle's position to determine when it exits the blind spot zone. Once the vehicle exits the blind spot, at step 420 the warnings are deactivated and transmission of warning messages ceases.

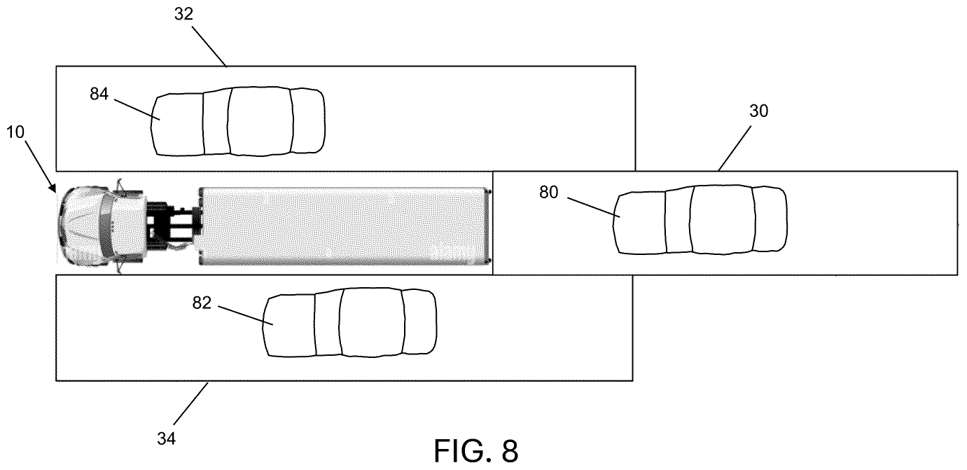

Referring next to FIG. 8, a practical application scenario illustrates the BSW-H system operation. A heavy vehicle 10 travels in the right lane of a multi-lane highway. A first passenger vehicle 80 approaches from the rear in the same lane, entering Blind Spot Zone #1 (rear blind spot 30). The BSW-H system detects vehicle 80 and transmits a warning message. The driver of vehicle 80 receives visual and auditory warnings indicating “WARNING: ENTERING BLIND SPOTS OF HEAVY VEHICLE” and responds by either accelerating to pass the truck or decelerating to maintain a safe following distance outside the blind spot.

A second passenger vehicle 82 travels in the adjacent left lane alongside the heavy vehicle 10, occupying Blind Spot Zone #3 (left-side blind spot 34). The system detects vehicle 82 and continuously transmits warnings as long as vehicle 82 remains in Zone #3. If the truck driver activates a left turn signal indicating an intention to change lanes, the warning priority level escalates, potentially increasing the auditory warning frequency to provide more urgent notification to the driver of vehicle 82.

A third passenger vehicle 84 travels in the adjacent right lane slightly behind the heavy vehicle 10, entering Blind Spot Zone #2 (right-side blind spot 32). This represents the highest-risk scenario, as right-side blind spots are associated with the majority of truck-related blind spot crashes. The BSW-H system immediately detects vehicle 84 upon entry to Zone #2 and transmits continuous warnings. The driver of vehicle 84 receives the alert and takes appropriate action to exit the blind spot zone by either accelerating past the truck or decelerating to fall back behind the blind spot zone.

This “hedging” approach significantly enhances safety by ensuring that both the truck driver and each passenger vehicle driver receive independent warnings about blind spot hazards. Statistical evidence demonstrates that this dual-warning strategy effectively modifies driver behavior, reducing time spent in dangerous blind spot zones and encouraging safer driving practices around large trucks.

The foregoing BSW-H system addresses a critical safety need in the commercial trucking industry and contributes to the broader goals of reducing traffic fatalities. With over 5,936 fatalities in large truck crashes in 2022, of which 70% were occupants of other vehicles, technologies that reduce blind spot crashes can save hundreds of lives annually. The system is particularly valuable for trucking fleets seeking to reduce collision rates and associated costs, and for passenger vehicle manufacturers seeking to enhance vehicle safety features.

The system is compatible with emerging Connected Vehicle infrastructure and autonomous vehicle technologies and can be readily integrated into the evolving intelligent transportation ecosystem. As vehicle-to-vehicle communication becomes increasingly prevalent, the BSW-H system provides immediate safety benefits while establishing a foundation for more sophisticated cooperative driving systems.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. Thus, it should be understood, therefore, that the invention may be practiced otherwise than as specifically set forth herein.

1. A collision avoidance system for reducing blind spot related crashes, comprising:
a monitoring vehicle including:
a plurality of sensors positioned around the monitoring vehicle and configured to detect positions and velocities of surrounding vehicles;
a processor configured to:
define at least one blind spot region associated with the monitoring vehicle, the blind spot region comprising an area where a driver of the monitoring vehicle has impaired visibility; and
determine when a target vehicle has entered the at least one blind spot region based on position data from the plurality of sensors; and
a communication module configured to transmit a wireless warning signal to the target vehicle when the processor determines that the target vehicle is within the at least one blind spot region;
wherein the wireless warning signal causes a warning device within the target vehicle to present an alert to an occupant of the target vehicle indicating the target vehicle's proximity to the monitoring vehicle's blind spot;
wherein the warning is provided to the target vehicle independently of whether the monitoring vehicle's driver is aware of the target vehicle's presence.

2. The system of claim 1, wherein the at least one blind spot region comprises:
a rear blind spot region extending between approximately 11 meters and 15 meters from a rear bumper of the monitoring vehicle and spanning a width between approximately 2.8 meters and 3.8 meters;
a first side blind spot region extending from a front bumper of the monitoring vehicle along a length of the monitoring vehicle and continuing between approximately 4 meters and 6 meters past the rear bumper, the first side blind spot region having a width between approximately 2.8 meters and 3.8 meters; and
a second side blind spot region positioned on an opposite side of the monitoring vehicle from the first side blind spot region and having dimensions substantially similar to the first side blind spot region.

3. The system of claim 1, wherein the warning device within the target vehicle comprises:
a visual indicator configured to display a text message indicating entry into the blind spot region; and
an auditory indicator configured to generate a sound repeating at intervals of approximately one second while the target vehicle remains within the at least one blind spot region.

4. The system of claim 1, wherein the processor is further configured to:
calculate an overlap percentage indicating a portion of the target vehicle's footprint that overlaps with a boundary of the at least one blind spot region;
determine a warning intensity level based on the overlap percentage; and
wherein the wireless warning signal includes the warning intensity level for controlling an intensity of the alert presented within the target vehicle.

5. The system of claim 1, wherein the communication module utilizes at least one of:
Dedicated Short-Range Communications (DSRC) operating in a 5.9 GHz frequency band;
Cellular Vehicle-to-Everything (C-V2X) communication operating on Long-Term Evolution (LTE) or fifth-generation (5G) or future cellular networks; and
wherein the communication module transmits the wireless warning signal at a rate of at least 1 Hz while the target vehicle occupies the at least one blind spot region.

6. The system of claim 1, further comprising:
a data logging module configured to record operational data including:
timestamps of blind spot entry and exit events;
position coordinates and velocity vectors of detected vehicles;
warning transmission timestamps; and
vehicle trajectory data recorded at intervals of at most 0.01 seconds.

7. The system of claim 1, wherein the processor is further configured to:
determine a relative velocity between the monitoring vehicle and the target vehicle;
calculate a time to collision metric based on the relative velocity and a distance between the vehicles; and
adjust a warning urgency level based on the time to collision metric;
wherein when the time to collision is less than a threshold value, the processor increases the warning urgency level.

8. The system of claim 1, further comprising an internal warning display within a cab of the monitoring vehicle, the internal warning display configured to:
present a top-down representation of the monitoring vehicle;
display colored indicators showing which of the at least one blind spot region is currently occupied by one or more vehicles; and
generate auditory alerts within the cab when vehicles occupy the at least one blind spot region.

9. The system of claim 1, wherein the plurality of sensors comprise at least one of:
radar sensors having a detection range of at least 50 meters;
Light Detection and Ranging (LiDAR) sensors;
cameras configured to capture images of areas surrounding the monitoring vehicle; and
ultrasonic sensors;
wherein the processor performs sensor fusion to combine data from multiple sensor types to generate unified position and velocity estimates for the target vehicle.

10. The system of claim 1, wherein the processor is further configured to:
adjust dimensions of the at least one blind spot region based on:
whether a trailer is attached to the monitoring vehicle;
a length of an attached trailer;
ambient visibility conditions including time of day and weather conditions; and
vehicle speed of the monitoring vehicle.

11. A method for reducing blind spot related crashes, comprising:
monitoring, by a monitoring vehicle, a surrounding environment using a plurality of sensors to detect positions and velocities of surrounding vehicles;
defining at least one blind spot region associated with the monitoring vehicle, the blind spot region comprising:
a rear blind spot extending approximately 13 meters from a rear of the monitoring vehicle with a width of approximately 3.3 meters;
a right-side blind spot extending from a front of the monitoring vehicle along a length of the vehicle and continuing approximately 5 meters past the rear, with a width of approximately 3.3 meters; and
a left-side blind spot extending from the front along the length and continuing approximately 5 meters past the rear, with a width of approximately 3.3 meters;
determining that a target vehicle has entered one of the at least one blind spot region based on comparing position coordinates of the target vehicle against geometric boundaries of each blind spot region;
identifying which specific blind spot region of the at least one blind spot region has been entered by the target vehicle;
generating a warning message including an identifier of which blind spot region has been entered and vehicle dynamics data including at least one of velocity, heading, and intended maneuvers of the monitoring vehicle;
transmitting, via vehicle-to-vehicle wireless communication, the warning message to the target vehicle; and
continuing to transmit the warning message at a rate of at least 1 Hz while the target vehicle remains within the one of the at least one blind spot region;
wherein the warning message causes activation of at least one of a visual warning indicator and an auditory warning indicator within the target vehicle.

12. The method of claim 11, further comprising:
calculating an average speed of the target vehicle during a first time interval before the target vehicle enters the one of the at least one blind spot region;
calculating an average speed of the target vehicle during a second time interval after the target vehicle receives the warning message, the first time interval and the second time interval each having a duration of approximately 5 seconds;
determining a speed difference by subtracting the average speed during the first time interval from the average speed during the second time interval; and
recording the speed difference as a performance metric indicating effectiveness of the warning message in modifying driver behavior.

13. The method of claim 11, further comprising:
measuring a time duration from when the target vehicle enters the one of the at least one blind spot region until the target vehicle exits the blind spot region;
comparing the time duration against a baseline time duration measured when no warning message is transmitted; and
determining that the warning message effectively reduces time spent in blind spot regions when the time duration is statistically significantly less than the baseline time duration with a p-value less than 0.05.

14. The method of claim 11, further comprising:
receiving, by the monitoring vehicle, turn signal activation data indicating an intended lane change maneuver;
determining whether the intended lane change maneuver would move the monitoring vehicle into a lane currently occupied by the target vehicle within the one of the at least one blind spot region; and
when the intended lane change would conflict with the target vehicle position, increasing a warning priority level transmitted in the warning message to cause the target vehicle to present a more urgent alert to its driver.

15. The method of claim 11, further comprising:
activating an internal warning display within a cab of the monitoring vehicle to alert a driver of the monitoring vehicle that the target vehicle occupies the one of the at least one blind spot region;
wherein activating the internal warning display comprises displaying a colored indicator on a dashboard display, the colored indicator using:
a first color to indicate no vehicles in blind spot regions;
a second color to indicate vehicles approaching blind spot regions; and
a third color to indicate vehicles currently occupying blind spot regions.

16. A non-transitory computer-readable medium storing instructions that, when executed by a processor of a monitoring vehicle, cause the processor to perform operations comprising:
receiving sensor data from a plurality of sensors positioned around the monitoring vehicle, the sensor data including position and velocity information for surrounding vehicles;
determining whether any surrounding vehicle has entered a blind spot zone selected from:
a rear blind spot zone extending between 11 meters and 15 meters from a rear of the monitoring vehicle;
a right-side blind spot zone extending along a right side of the monitoring vehicle from a front bumper to at least 5 meters past a rear bumper; and
a left-side blind spot zone extending along a left side of the monitoring vehicle from the front bumper to at least 5 meters past the rear bumper;
upon determining that a target vehicle has entered one of the blind spot zones:
generating a warning message indicating which blind spot zone has been entered;
formatting the warning message according to a vehicle-to-vehicle communication protocol;
transmitting the warning message wirelessly to the target vehicle to cause presentation of an alert within the target vehicle;
continuing transmission at intervals of at most 1 second while the target vehicle remains in the blind spot zone; and
ceasing transmission within 100 milliseconds of the target vehicle exiting the blind spot zone.

17. The non-transitory computer-readable medium of claim 16, wherein the operations further comprise:
calculating an overlap percentage representing a portion of the target vehicle positioned within boundaries of the blind spot zone;
selecting a warning modality based on the overlap percentage, wherein:
when the overlap percentage is less than 50%, selecting visual warning only;
when the overlap percentage is between 50% and 75%, selecting combined visual and auditory warning; and
when the overlap percentage exceeds 75%, selecting combined visual and auditory warning with increased auditory frequency;
and including the selected warning modality in the warning message.

18. The non-transitory computer-readable medium of claim 16, wherein the operations further comprise:
recording, for each blind spot entry event, a dataset including:
a speed of the target vehicle;
a speed difference calculated over 5-second intervals before and after warning transmission;
a time duration spent by the target vehicle in the blind spot zone;
throttle position and brake force data if available from the target vehicle;
GPS coordinates of both the monitoring vehicle and the target vehicle;
a timestamp with millisecond precision; and
vehicle type classifications for both the monitoring vehicle and target vehicle; and
transmitting the recorded dataset to a remote server for statistical analysis of system effectiveness.

19. A system for promoting defensive driving around heavy vehicles, comprising:
a heavy vehicle equipped with:
sensing means for detecting passenger vehicles within defined zones surrounding the heavy vehicle;
processing means for determining when a detected passenger vehicle occupies a blind spot zone where a driver of the heavy vehicle has impaired visibility;
communication means for wirelessly transmitting warning signals to the detected passenger vehicle when the passenger vehicle occupies the blind spot zone;
wherein the warning signals conform to at least one vehicle-to-vehicle communication standard;
wherein the blind spot zones comprise:
a rear zone extending 13 meters±2 meters from a rear bumper with a width of 3.3 meters±0.5 meters;
a right-side zone extending from a front bumper along a vehicle length plus 5 meters±1 meter past a rear bumper, with a width of 3.3 meters±0.5 meters; and
a left-side zone with dimensions substantially equivalent to the right-side zone;
wherein the system implements a hedging safety strategy by providing warnings to both:
the driver of the heavy vehicle via an internal display in a cab of the heavy vehicle; and
a driver of the passenger vehicle via in-vehicle warning indicators activated by the wirelessly transmitted warning signals; and
wherein the system has been validated through empirical testing demonstrating statistically significant behavioral changes in driver behavior with p-values less than 0.05 when comparing warning scenarios to baseline scenarios without warnings.
